(19) United States
(12) Patent Application Publication
(10) Pub. No.: US 2026/0095305 A1
(43) Pub. Date: Apr. 2, 2026

(54) DEVICES, IN PARTICULAR RECEIVERS OR TRANSMITTERS, AND METHODS, IN PARTICULAR IN THE RECEIVER OR TRANSMITTER, FOR COMMUNICATION ENCRYPTED WITH A SESSION KEY

(71) Applicant: Robert Bosch GmbH, Stuttgart (DE)

(72) Inventors: Arthur Mutter, Neuhausen (DE); Friedrich Wiemer, Burgstetten (DE)

(21) Appl. No.: 19/336,895

(22) Filed: Sep. 23, 2025

(30) Foreign Application Priority Data
Oct. 1, 2024 (DE) 10 2024 209 604.0

(51) Int. Cl. H04L 9/08

(52) U.S. Cl. CPC H04L 9/0819; H04L 9/0861

(57) ABSTRACT

A device and a method, in a receiver, for communication encrypted with a session key, for determining the session key for the encrypted communication. A data frame is received, wherein the data frame includes a part encrypted with the session key, wherein the data frame includes an identifier outside the part encrypted with the session key, wherein the identifier identifies a key, in particular provided in the receiver, for generating the session key. A device and a method, in a transmitter, for communication encrypted with a session key, wherein a data frame is generated and is sent to a receiver, wherein the data frame includes a part encrypted with the session key, wherein the data frame includes an identifier outside the part encrypted with the session key, wherein the identifier identifies a key, in particular provided in the receiver, for generating the session key.

### FIELD

The present invention relates to a device, in particular a receiver or a transmitter, and a method, in particular in the receiver or in the transmitter, for communication encrypted with a session key.

### BACKGROUND INFORMATION

Communication encrypted with a session key requires an agreement on the session key. For example, the session key is determined on the basis of a key that is available in the transmitter and the receiver for the encrypted communication.

### SUMMARY

Methods and devices according to the present invention provide the receiver of a data frame with the information to derive the session key required to decrypt the data frame by means of an inband key agreement protocol. This simplifies key handling, as only one master key needs to be stored, and shortens the time until the session key is available in a scenario in which the receiver has a plurality of keys available for encrypted communication.

According to an example embodiment of the present invention, a first method, in particular in a receiver, for communication encrypted with a session key, in particular for determining the session key for the encrypted communication, provides that a data frame is received, wherein the data frame comprises a part encrypted with the session key, wherein the data frame comprises an identifier outside the part encrypted with the session key, wherein the identifier identifies a key, in particular provided in the receiver, for generating the session key. The key is, for example, a long-term key, i.e. a key that is suitable for generating a plurality of session keys.

The first method provides, for example, that a plurality of keys are provided, in particular in the receiver, each of which is assigned to a group of nodes of a communication network, wherein the key is selected from the plurality of keys on the basis of the identifier, and the session key is determined on the basis of the key. This enables encrypted communication in different groups of transmitters and receivers, each of which is assigned a key.

The first method provides, for example, that the session key is assigned to a key number, wherein the data frame comprises the key number outside the part encrypted with the session key, and wherein the session key is determined on the basis of the key and the key number. The key number is assigned, for example, to a packet number of the data frame. The packet number is unique for the key number. This structure of the data frame and the encrypted communication is compatible, for example, with MACsec encryption.

The first method provides, for example, that the identifier is at least 8 bits or at least 16 bits long. This ensures that a sufficient number of keys can be identified, in particular for in-vehicle networks.

The first method provides, for example, that the identifier is a number, in particular an integer greater than zero. The identifier as a number makes handling easier.

The first method provides, for example, that the data frame for communication encrypted with MACsec encryption is received via Ethernet, wherein the data frame comprises a MACsec data frame as a part encrypted with the session key, or that the data frame for communication encrypted with CANsec encryption is received via CAN-XL, wherein the data frame comprises a CANsec data frame as a part encrypted with the session key.

The first method provides, for example, that the key number is checked for freshness, and the session key is determined on the basis of the key and the key number if the freshness of the session key is determined and the session key is otherwise not used or is not determined on the basis of the key and the key number. In this way, the presence of the current session key is detected and it is used.

According to an example embodiment of the present invention, a second method, in particular in a transmitter, for communication encrypted with a session key, provides that a data frame is generated, wherein the data frame is sent in particular to a receiver, wherein the data frame comprises a part encrypted with the session key, wherein the data frame comprises an identifier outside the part encrypted with the session key, wherein the identifier identifies a key, in particular provided in the receiver, for generating the session key.

The second method provides, for example, that the session key is assigned to a key number, wherein the data frame comprises the key number outside the part encrypted with the session key. This structure of the data frame and the encrypted communication is compatible, for example, with MACsec encryption.

The second method provides, for example, that the identifier is determined, wherein the identifier is at least 8 bits or at least 16 bits long.

The second method provides, for example, that the identifier is determined as a number, in particular as an integer greater than zero.

The second method provides, for example, that the data frame for communication encrypted with MACsec encryption is sent via Ethernet, wherein the data frame comprises a MACsec data frame as a part encrypted with the session key, or that the data frame for communication encrypted with CANsec encryption is sent via CAN-XL, wherein the data frame comprises a CANsec data frame as a part encrypted with the session key.

The second method provides, for example, that the key number is determined so that the key number can be checked for freshness.

According to an example embodiment of the present invention, a first device, in particular a receiver, for communication encrypted with a session key is designed to carry out the first method of the present invention.

According to an example embodiment of the present invention, a second device, in particular a transmitter, for communication encrypted with a session key is designed to carry out the second method of the present invention.

According to an example embodiment of the present invention, a computer program can be provided, wherein the computer program comprises computer-readable instructions, upon the execution of which by a computer, the first or the second method of the present invention is executed.

### BRIEF DESCRIPTION OF THE DRAWINGS

Further advantageous embodiments can be found in the following description and the figures.

FIG. 1 shows a schematic representation of a communication network, according to an example embodiment of the present invention.

FIG. 2 shows a schematic representation of a data frame, according to an example embodiment of the present invention.

FIG. 3 is a sequence diagram, according to an example embodiment of the present invention.

### DETAILED DESCRIPTION OF EXAMPLE EMBODIMENTS

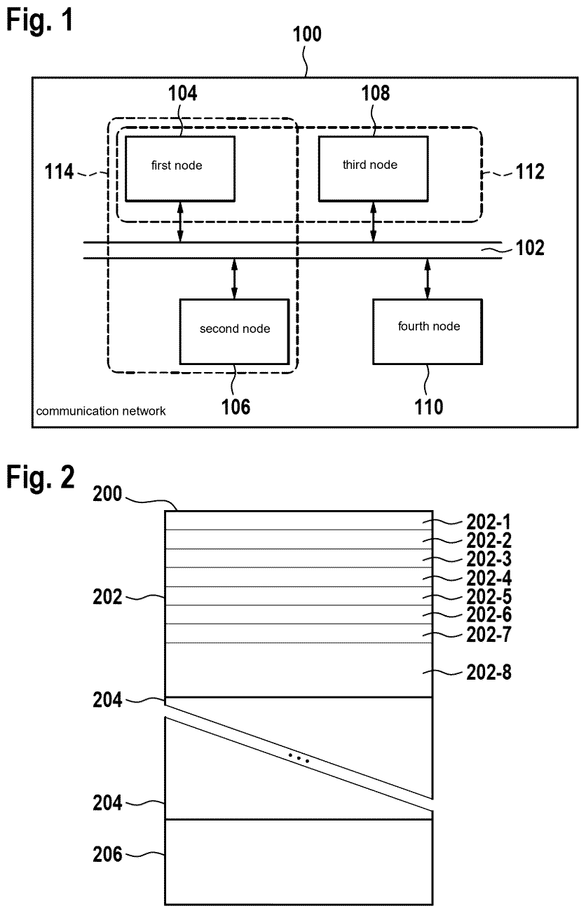

FIG. 1 schematically shows a communication network 100. The communication network 100 comprises a communication connection 102.

The communication network 100 shown by way of example in FIG. 1 comprises a first node 104, a second node 106, a third node 108 and a fourth node 110. The communication network 100 is not limited to four nodes. More than two nodes may be provided, e.g. three or more than four nodes.

The nodes are configured to communicate via the communication connection 102. For example, the nodes exchange messages for communication. The messages are transmitted, for example, in data frames via the communication connection 102.

The communication connection 102 comprises, for example, a communication bus. The communication bus is, for example, Ethernet-based (10Base-T1S), CAN-based (e.g. CAN XL).

The communication network 100 is, for example, an In-Vehicle Network (IVN).

The communication connection 102 uses a data plane for communication.

The communication connection 102 uses a security protocol to protect messages in the data plane with respect to authenticity, integrity, freshness, and confidentiality.

Examples of the security protocol are

### Media Access Control Security (MACsec) for Ethernet Controller Area Network Security (CANsec) for CAN XL.

MACsec and CANsec use a hierarchical structure of logical concepts for the actual securing of the communication in the messages in the data plane.

At the highest level, the Connectivity Association (CA) defines a group of nodes in the communication network 100 that are to communicate securely with each other.

FIG. 1 shows, by way of example, a first CA 112 and a second CA 114. The first CA 112 comprises the first node 104 and the third node 108. The second CA 114 comprises the first node 104 and the second node 106.

Each CA is assigned a key, in this example a Connectivity Association Key (CAK), which is, for example, made available to the nodes as a Pre-Shared Key (PSK). Within the CA, each node has a sending Secure Channel (SC) which is managed by the other participants of the CA as the receiving SC. The SCs influence a technical value that flows into the cryptographic algorithms used (the so-called nonce). It is provided that this value is used a maximum of once. The different SCs thus ensure that race conditions on the nonce are prevented. Finally, within the SC there are so-called Secure Associations (SAs), to which the actual session key, i.e., Session Key (SAK), is assigned. On the temporal axis, a plurality of SAs can exist in parallel. This ensures that the derivation of session keys during operation is less time-critical.

For example, the session keys of the SAs, i.e., the SAKs, are regularly renegotiated. For example, the SAKs are renegotiated when the communication network 100 starts. With the IVN, for example, the SAKs are renegotiated when the vehicle in which the IVN is arranged is started.

For this purpose, a key agreement protocol is used. For MACsec, MACsec Key Agreement (MKA) is specified in IEEE 802.1X for this purpose.

For the security protocol, e.g. MACsec or CANsec, an Inband Key Agreement (IKA) protocol is provided, with which an SAK is determined directly from the key, e.g. the CAK, that is already present in the nodes and on the basis of an identifier. The identifier identifies the key, in particular the CAK or CA, i.e. the group. The identifier is, for example, a CA Identifier (CA-ID). The inband key agreement protocol can provide that the SAK is determined on the basis of additional information. An example of additional information is a Key Number (KN).

This means that the SAKs are generated in each node itself. This means that the SAKs are not distributed securely by a central key server instance, in particular not as with MKA.

A message secured with the security protocol and the protocol is transmitted in a data frame.

FIG. 2 schematically shows an example 200 of the data frame. According to the example 200, the data frame is an Ethernet data frame.

The data frame according to the example 200 comprises a header 202. The data frame according to the example 200 comprises user data 204, i.e. payload. The data frame according to the example 200 comprises a trailer 206.

The data frame according to the example 200 comprises, in the header 202, data fields for the following content, which is arranged, according to a first variant, in the data fields as follows:
202-1: Destination address
202-2: Address of origin
202-3: EtherType IKA
202-4: CA-ID
202-5: SCPI
202-6: KN
202-7: EtherType MACsec
202-8: MACsec header

The MACsec header is part of a MACsec data frame that comprises a Packet Number (PN) assigned to the SAK. The PN is unique to the SAK.

The data fields 202-4: CA-ID, 202-5: SCPI, 202-6: KN represent an IKA header. The data field 202-3: EtherType IKA indicates that the IKA header follows.

The data fields 202-3: EtherType IKA, 202-4: CA-ID, 202-5: SCPI, 202-6: KN are not encrypted with the SAK.

The nodes assigned to the same CA form a CA group. The CA-ID provides an explicit identifier for the CA group. This allows easy identification and management of a plurality of parallel CAs per node.

By including the CA-ID in the header 202, nodes can directly identify the correct CA and the corresponding CAK without the need for an implicit determination based on the SCs using the Secure Channel Identifier (SCI). This simplifies the key agreement process, reduces the amount of logic required, and improves scalability.

The CA-ID enables more granular and more secure management of CA groups and facilitates integration and scalability in complex network environments.

The ability to diagnose the protocol in network recordings is simplified because the relevant information is visible directly in the header 202.

A different arrangement of the content in the data fields can also be provided, for example in the following variants.

### Variant 2:

202-1: Destination address
202-2: Address of origin
202-3: EtherType IKA
202-4: SCPI
202-5: CA-ID
202-6: KN
202-7: EtherType MACsec
202-8: MACsec header

### Variant 3:

202-1: Destination address
202-2: Address of origin
202-3: EtherType IKA
202-4: SCPI
202-5: KN
202-6: CA-ID
202-7: EtherType MACsec
202-8: MACsec header

For example, the MACsec security protocol for Ethernet provides that a MACsec data frame is transmitted in an Ethernet data frame. The IKA header is added, for example, to the Ethernet data frame in addition to the MACsec data frame. The key derivation is then performed for each MACsec data frame based on the IKA information in the IKA header from the Ethernet data frame that comprises the corresponding MACsec data frame.

For example, the CANsec security protocol for CAN XL provides that a CANsec data frame is transmitted in a CAN XL data frame. The IKA header is added, for example, to the CAN XL data frame in addition to the CANsec data frame. The key derivation is then carried out for each CANsec data frame based on the IKA information in the IKA header from the CAN XL data frame that comprises the corresponding CANsec data frame.

The number of bits of the CA-ID data field is e.g. 8 or 16 bits. This makes a sufficiently large number of CAs identifiable.

Other data field widths for the CA-ID are also possible.

The encoding of the CA-ID can be left to a user. For example, the CA-ID is encoded as a number.

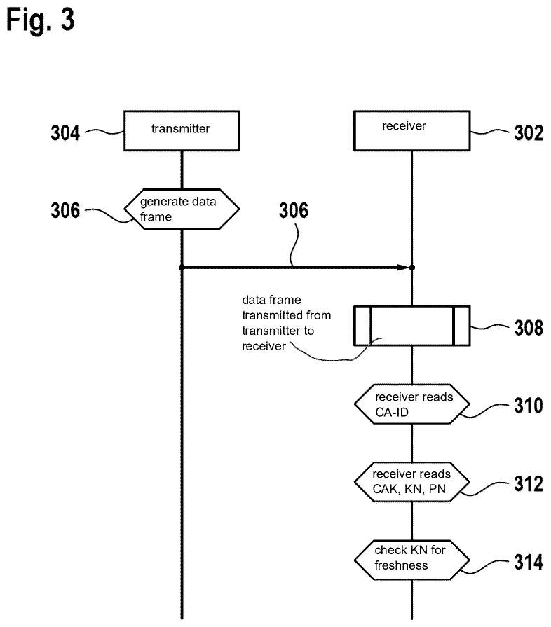

FIG. 3 is a sequence diagram with steps of a method for determining an SAK by means of a receiver 302 using MACsec for Ethernet, as an example. The receiver 302 is, for example, the first node 104 of the communication network 100.

In the example, the MACsec data frame comprises a Packet Number (PN) which is unique to the SAK.

The method provides that a transmitter 304 generates the data frame 200 according to variant 1 in a step 306. The transmitter 304 is, for example, the third node 108 of the communication network 100.

In the example, the transmitter 304 and the receiver 302 are assigned to the first CA 112. In the example, the CA-ID in the data frame 202 is assigned to the first CA 112.

The transmitter 304 generates the data frame 200 in the example for transmission from the transmitter 304 to the receiver 302. The transmitter 304 generates the data frame 200 in the example with the CA-ID assigned to the first CA 112.

In a step 308, the data frame 200 is transmitted from the transmitter 304 to the receiver 302.

In a step 310, the receiver 302 reads the CA-ID from the data field 202-4. This means that the receiver 302 identifies the CA assigned to the CA-ID, in the example the first CA 112.

This means that the CA is realized by directly reading the CA-ID. If the data field 202-4 CA-ID is instead not present, a lookup would have to be performed based on, for example, the SCI, which in turn would point to the corresponding CA. This means that step 310 eliminates the need for the lookup and better decouples the data plane from the control plane, since the SCI information is part of the data plane.

In a step 312, the receiver 302 reads
the CAK of the CA assigned to the CA-ID, in particular from an internal memory of the receiver 302,
the KN from data field 202-6, and
the PN from the MACsec data frame.

This means that the receiver 302 determines a status of the IKA that comprises at least CAK, KN, PN.

In a step 314, the KN is checked for its freshness.

In a step 316, the SAK is determined on the basis of the CAK and KN.

It can be provided that the method is terminated if it is determined during the check for freshness that the KN is not up-to-date.

It can be provided to not use the SAK if it is determined during the freshness check that the KN is not up-to-date.

For the data frame 200 according to one of the other variants, the same method is used.

For CANsec, a structure of a CAN XL data frame corresponding to the data frame 200 is provided, which provides data fields for the IKA header. The steps of the method are performed for the CAN XL data frame as described for the Ethernet data frame 200.

1-16. (canceled)

17. A method in a receiver for communication encrypted with a session key including for determining the session key for the encrypted communication, the method comprising:
receiving a data frame, wherein the data frame includes a part encrypted with the session key, wherein the data frame includes an identifier outside the part encrypted with the session key, wherein the identifier identifies a key provided in the receiver for generating the session key.

18. The method according to claim 17, wherein a plurality of keys are provided in the receiver, each of the plurality of keys being assigned to a group of nodes of a communication network, wherein the key is selected from the plurality of keys based on the identifier, and the session key is determined based on the key.

19. The method according to claim 17, wherein the session key is assigned to a key number, wherein the data frame includes the key number outside the part encrypted with the session key, and wherein the session key is determined based on the key and the key number.

20. The method according to claim 17, wherein the identifier is at least 8 bits or at least 16 bits long.

21. The method according to claim 17, wherein the identifier is a number, the number being an integer greater than zero.

22. The method according to claim 17, wherein: (i) the data frame is for communication encrypted with MACsec encryption and is received via Ethernet, wherein the data frame includes a MACsec data frame as the part encrypted with the session key, or (ii) the data frame is for communication encrypted with CANsec encryption and is received via CAN-XL, wherein the data frame includes a CANsec data frame as the part encrypted with the session key.

23. The method according to claim 19, wherein the key number is checked for freshness, and wherein the session key is determined based on the key and the key number when the freshness of the session key is determined, and the session key is otherwise not used or is not determined based on the key and the key number.

24. A method in a transmitter for communication encrypted with a session key, the method comprising:
generating a data frame; and
sending the data frame to a receiver;
wherein the data frame includes a part encrypted with the session key, wherein the data frame includes an identifier outside the part encrypted with the session key, wherein the identifier identifies a key, provided in the receiver, for generating the session key.

25. The method according to claim 24, wherein the session key is assigned to a key number, wherein the data frame includes the key number outside the part encrypted with the session key.

26. The method according to claim 24, wherein the identifier is determined, and wherein the identifier is at least 8 bits or at least 16 bits long.

27. The method according to claim 24, wherein the identifier is determined as a number, the number being an integer greater than zero.

28. The method according to claim 24, wherein: (i) the data frame is for communication encrypted with MACsec encryption and is sent via Ethernet, wherein the data frame includes a MACsec data frame as the part encrypted with the session key, or (ii) the data frame for communication is encrypted with CANsec encryption and is sent via CAN-XL, wherein the data frame include a CANsec data frame as the part encrypted with the session key.

29. The method according to claim 25, wherein the key number is determined so that the key number can be checked for freshness.

30. A device, comprising:
a receiver configured for communication encrypted with a session key, the device being configured to:
receive a data frame, wherein the data frame includes a part encrypted with the session key, wherein the data frame includes an identifier outside the part encrypted with the session key, wherein the identifier identifies a key provided in the receiver for generating the session key.

31. A device, comprising:
a transmitter configured for communication encrypted with a session key, wherein the device is configured to:
generate a data frame, and
send the data frame to a receiver,
wherein the data frame includes a part encrypted with the session key,
wherein the data frame includes an identifier outside the part encrypted with the session key, wherein the identifier identifies a key, provided in the receiver, for generating the session key.

32. A non-transitory computer-readable medium on which is stored a computer program including computer-readable instructions for communication encrypted with a session key including for determining the session key for the encrypted communication, the instructions, when executed by a computer of a receiver, causing the computer to perform:
receiving a data frame, wherein the data frame includes a part encrypted with the session key, wherein the data frame includes an identifier outside the part encrypted with the session key, wherein the identifier identifies a key provided in the receiver for generating the session key.
